(19) United States
(12) Patent Application Publication
(10) Pub. No.: US 2023/0222398 A1
(43) Pub. Date: Jul. 13, 2023

(54) Systems and Methods for Trip Planning

(71) Applicant: Foram Gandhi, Cupertino, CA (US)

(72) Inventor: Foram Gandhi, Cupertino, CA (US)

(21) Appl. No.: 17/572,882

(22) Filed: Jan. 11, 2022

(51) Int. Cl. G06Q 10/02; G06F 3/0482

(52) U.S. Cl. CPC G06Q 10/025; G06F 3/0482

(57) ABSTRACT

A web application to store people’s itinerary. The system handles Itinerary with time, place and activity and has the ability to search other people’s itinerary, clone it and make changes to fit their own purpose and ability to share the user itinerary with other people for viewing and for editing.

### BACKGROUND

On average people spend 3 hours to plan their itinerary. The invention is supposed to reduce time to plan and get a fulfilling trip experience.

Whenever a family takes a trip, a trip requires planning on the destination to go to, the activities to do and the sights to see. To get the maximum experience, much time and collaboration occur for every member of the family to agree to the trip details.

There are so many travel books and traveler guides published which help people choose activities and restaurants. The demand for people to explore new places and try out new things combined with hearing about other travel journeys is well known in the printed world. However, it has not translated into the digital world which need not be just listings but coherent itinerary which allows for schedule to go visit the places and transportation and time required all combined to make informed decisions on a trip.

Pictures relating to the thing the user are doing alone are most relevant. When someone sees a friend’s album, it’s really confusing to understand where a picture was taken or what was happening when the picture was taken. Also it’s an overload of a lot of pictures without any order in which pictures are shown. Organizing pictures by activities during a trip helps one to grasp what the picture is about and enjoy the viewing experience of the audience with which the trip is shared. Personal viewing of the pictures too is more enjoyable when associated with the activity that was being done when the picture was taken.

### SUMMARY

A web application to store people’s itinerary. Itinerary with time, place and activity. Ability to search other people’s itinerary, clone it and make changes to fit their own purpose. Ability to share the user itinerary with other people for viewing and for editing.

The intent is to decrease time to build an itinerary by taking inspiration from other people’s itinerary so that the user don’t have to build it all on the user own. The application should work on desktop browser or on mobile web browser.

Users should be able to edit their itinerary and add photos taken at a particular location or activity. It can also be very helpful for vacations, weddings and events with a schedule.

Software program which incorporates the logic to search for itineraries. The logic and user experience flow to clone an itinerary. The logic and UI to add photos to an activity. The logic and UI to view past itineraries and shared itineraries. The logic and UI to share the itinerary with friends and family to view and edit. The database stores the data for individual itineraries and association of the person with the itinerary. The UI screenshots are attached. The trip is structured from an origin to destination. If multiple destinations are there, then the final destination should be entered as the destination.

For a trip, people have to communicate via disorganized chats and phone calls. This app allows the itinerary to be organized for easy access, updates and sharing. The app also allows one to earn money for sharing the itinerary if someone sees an ad on the itinerary created by an individual. If the trip is edited by multiple people, the money is divided equally across all participants. The entire lifecycle of the itinerary is described below:

Efficiency in trip creation is obtained by
cloning an existing itinerary
cloning parts of another itinerary into one’s own itinerary
Check into a location while on the trip Efficiency in trip sharing is done by
Adding photos to the activity/ location. Hence eliminating confusion on location
Data structures & technical flows:
Cloning trip from a unique combination of trips for trip activity, trip type, destination and duration in search result: Deduction needs to be made on which trip to clone out of the numerous trips for a combination of trip activities list, trip type, destination & duration. The logic chooses the most reviewed and top rated trip. In absence of the reviews, choose the trip which is most complete. If multiple trips are complete, choose the latest one. Definition of complete is that all the days are filled. There is travel at the start and end of the trip, there is stay at the end of each day. There is food consumption each day. Efficiency is obtained by choosing the fastest path to getting to the perfect itinerary to clone.(personalization)

Advantages may include one or more of the following. The website allows families to look at various itineraries to choose one that would most closely fit the family and clone it for themselves. This gives a starting point to build a personal itinerary for the family. Not only family but friends going together can build their own itinerary.

### BRIEF DESCRIPTION

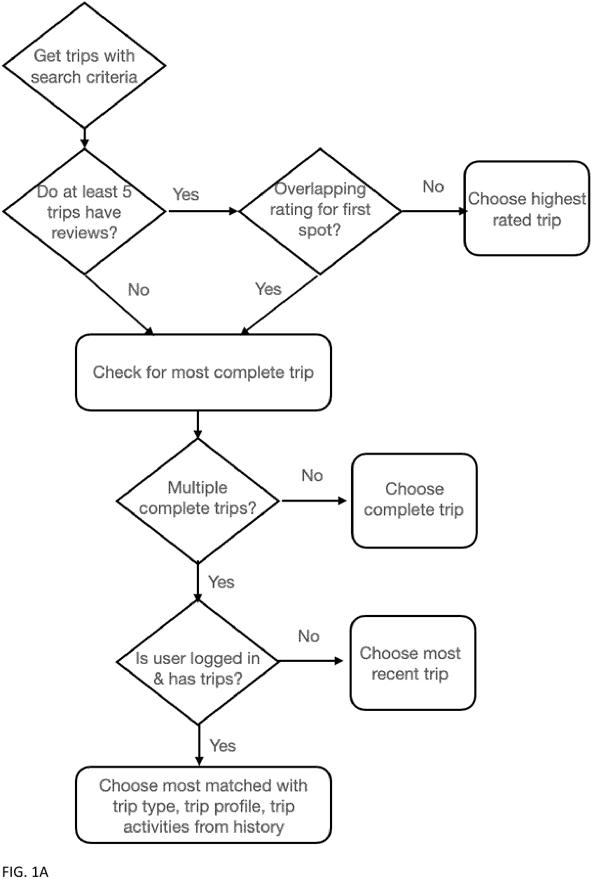

FIGS. 1A-1B show an exemplary process for travel planning.

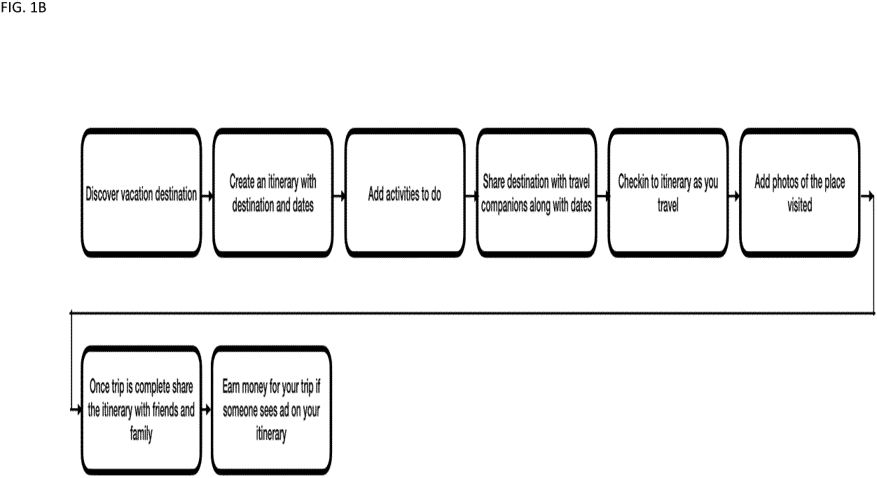

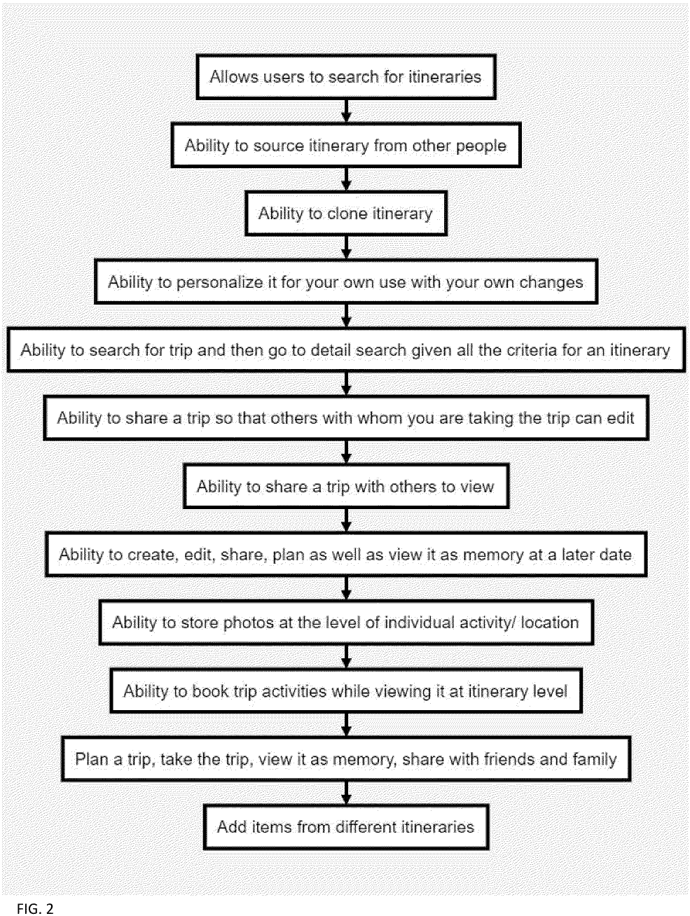

FIG. 2 shows one implementation of FIG. 1.

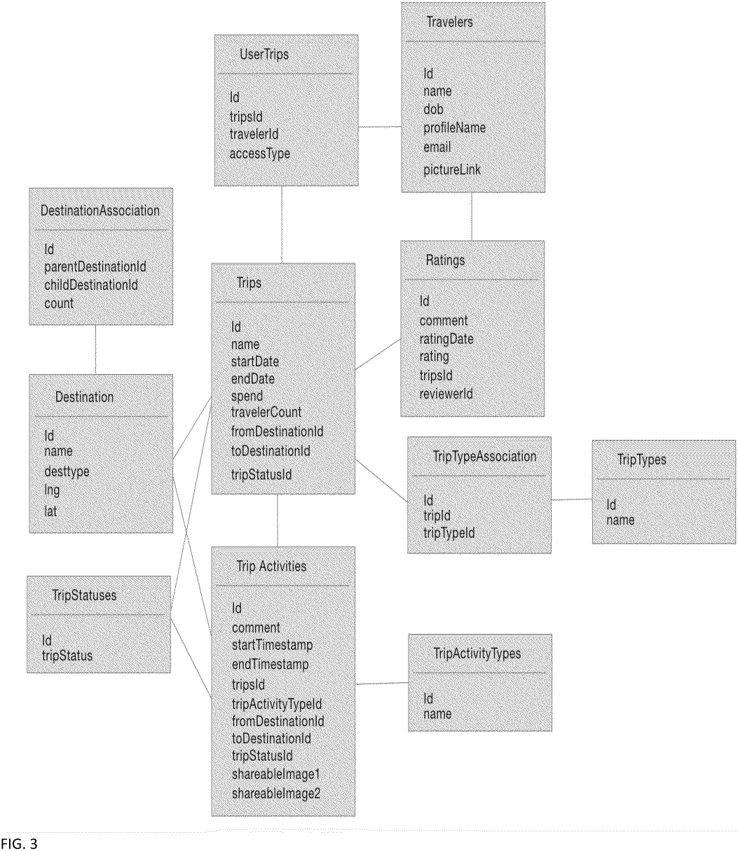

FIG. 3 shows an exemplary database module used in FIG. 1.

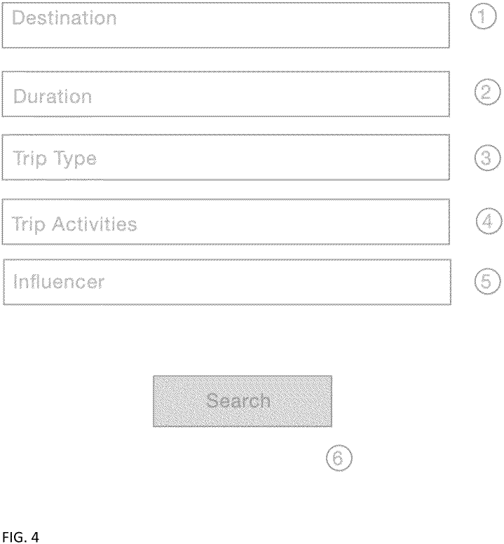

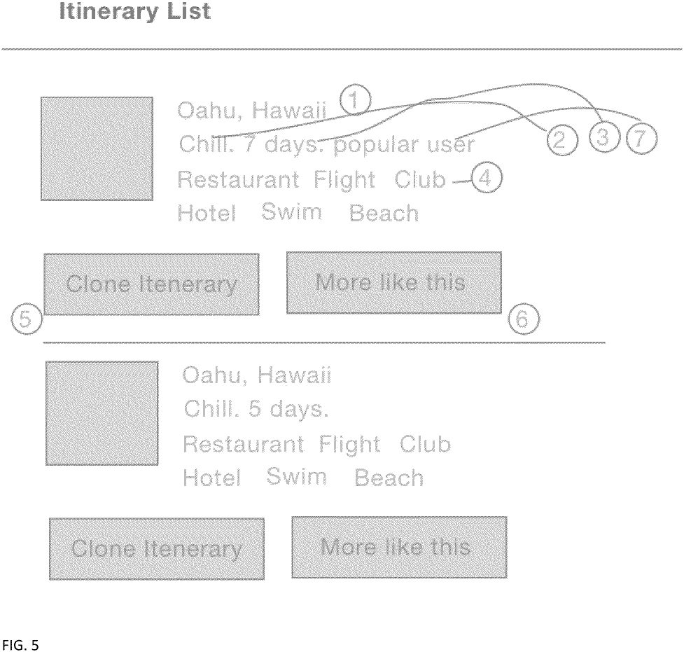

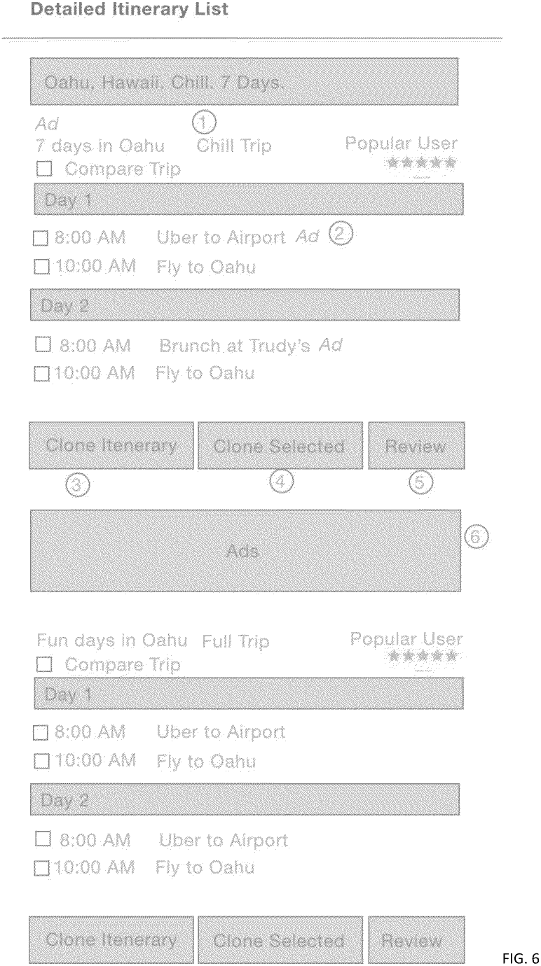

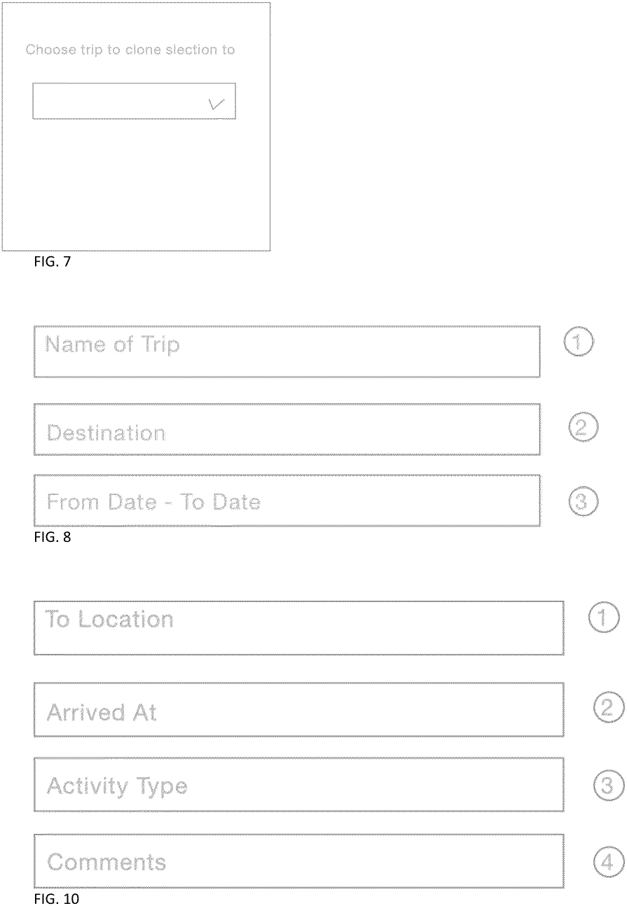

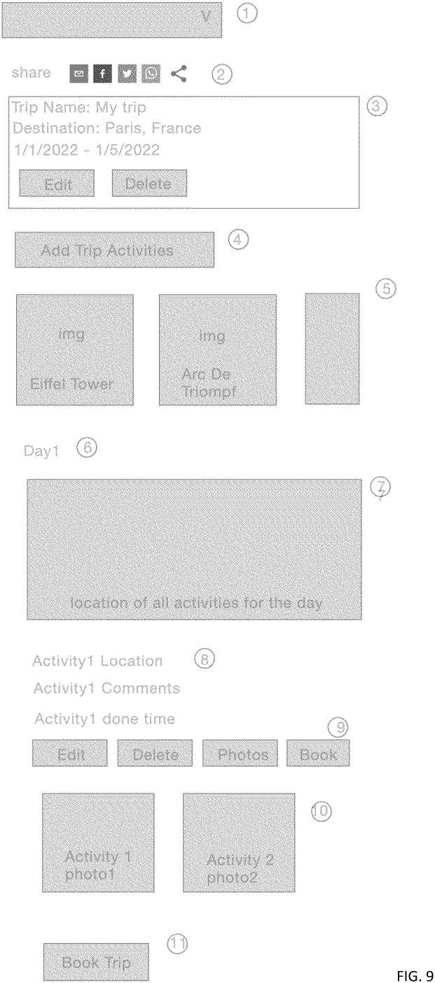

FIGS. 4-10 show exemplary user interface for the system of FIG. 1.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

FIG. 1A shows an exemplary process for travel planning. A user initially locates trips of interest using search criteria. The process checks for sufficiency of reviews and then selects the highest rated trip. Popular destinations may have insufficient reviews, or alternatively may have too many overlapping first spot rankings and if so the process selects the most complete trip to recommend. Next, the process checks if the sample itineraries represent complete trips and selects the most completed trip to follow. The process then checks for most recent trips for use. Once this is done, the process recommends the best matched trip based on trip type, profile and activities from the trip history.

FIG. 1A can be a web application (app) or a mobile app which helps in the creation of itineraries for vacations, business trips, weddings, events etc. and helps to share them with friends and family. The website also allows people to add photos and notes to each activity performed during the trip. It is more helpful when used in conjunction with travel guides like Lonely Planet, Frommers, Yelp, Trip Advisor etc.

FIG. 1B shows one exemplary software program which incorporates the logic to search for itineraries. The logic and user experience flow to clone an itinerary. The logic and UI to add photos to an activity. The logic and UI to view past itineraries and shared itineraries. The logic and UI to share the itinerary with friends and family to view and edit. The database stores the data for individual itineraries and association of the person with the itinerary. The UI screenshots are attached. The trip is structured from an origin to destination. If multiple destinations are there, then the final destination should be entered as the destination.

The app allows the itinerary to be organized for easy access, updates and sharing. The app also allows one to earn money for sharing the itinerary if someone sees an ad on the itinerary created by an individual. If the trip is edited by multiple people, the money is divided equally across all participants. The method includes:
viewing one or more prior trip files shared by one or more travelers, wherein the trip file includes images and descriptions of one or more sub-destinations in the prior trips, activities done, and routes and travel methods to get to the one or more sub-destinations;
selecting a prior itinerary based on trip images and trip description type, activities done, person who created the itinerary, destination, and duration;
cloning a complete or a part of itinerary from the prior trip;
modifying the trip to fit a user preference;
sharing itinerary with co-travelers for edits;
booking all components of the itinerary; and
auto checking in at the one or more points of interest and travel.

Efficiency in trip creation for the computer system is obtained by:
cloning an existing itinerary
cloning parts of another itinerary into one’s own itinerary
checking into a location while on the trip.

Efficiency in trip sharing for the system is done by adding photos to the activity/ location.

Cloning trip from a unique combination of trips for trip activity, trip type, destination and duration in search result is also efficient for the system. The deduction needs to be made on which trip to clone out of the numerous trips for a combination of trip activities list, trip type, destination & duration. The logic chooses the most reviewed and top rated trip. In absence of the reviews, choose the trip which is most complete. If multiple trips are complete, choose the latest one. Definition of complete is that all the days are filled. There is travel at the start and end of the trip, there is stay at the end of each day. There is food consumption each day. Efficiency is obtained by choosing the fastest path to getting to the perfect itinerary to clone (personalization).

In detailed view, (i.e. when user clicks ‘More’ to get more details of itinerary: same logic is used in sorting search results as described above. Except, instead of choosing one, the ranking of the trip is determined.

Destination association: Keep a mapping for destination association from parent destination to child destination eg. Paris is the parent destination and the Eiffel tower is the child destination. If you visit Paris, in your trip, the trip activities to choose from would show the Eiffel tower as an option to add to the trip. This information is extracted from the trips created by various people on the platform and stored once. Efficiency is obtained by repeated use of the association over all trips to a particular parent destination.

Triptype association: we deduct a trip type out of the activities done on a trip. Eg. If a person stays in a hotel, goes to a spa, goes to restaurants nearby, then it’s deduced that it’s a relaxing trip. This is done by the program by tagging activity types as relaxing. If all activity types in a trip are in a category, then the trip is marked with the corresponding trip type. Efficiency is obtained by tagging the trip activity types to trip type so that the same mapping can be used across all trips.

Users can search for trips based on activities they would like to do, based on destination and based on duration they wish to go on the trip for. Any of the criteria can be entered or user can choose one of the destination images to choose the destination to go to. The search results will be a list of activities, destination and duration. Sorting can be done based on the latest or most popular trip. Users can choose one card to see more details of the trip. Users can give ratings to the trips as well.

Users can clone a trip for their own purpose to be able to start planning for their own trip.

Users can choose to go on their trips created in the past. By default the most recent trip is shown. There is a dropdown to choose the trip they wish to see. As activities and location are added, a map is displayed to show the location of various activities. The trip screen allows the user to edit the itinerary, add photos or video to an activity and change timing. Also new activities can be added to the trip.

A trip can be shared for viewing via a link to the trip via whatsapp, facebook, email. In order to share an itinerary for sharing for edit, a share icon is clicked which will send email to the recipient. The recipient can edit the trip the same as the original owner of the trip. However, the trip will appear in the shared tab on the menu. For the originator, the trip will appear in the trip tab.
User to search for trip itinerary
User to find itinerary they like
User to clone itinerary
User to find parts of itinerary they like and add to the trip
User to see their own itinerary
User to edit their own itinerary
User to share their itinerary with friends with clarity on the location where the photo was taken along with comments
Itinerary was shared with user who edits for things she wants to do. The changes are visible to the person with whom the itinerary is shared.

FIG. 2 shows one implementation of FIG. 1 while FIG. 3 shows an exemplary database module used in FIG. 1. In FIG. 2, the “Search For Itineraries” is done by searching for trip activities, and an example search query: · Bahamas_Beach, Miami Beach Activities: · Surfing · Snorkeling · Skydiving.

The application contains functionality to clone the itinerary for user’s own use or for sharing with other users. If there are many similar itineraries found in the search results, the application provides functionality to clone from a particular itinerary and not from all the itineraries. In the same way, if there are many different itineraries with small changes from a particular itinerary, the application provides functionality to clone from that particular itinerary. In case of multiple trips, the search result returns topmost trip having most reviews and top ratings. Hence the application first searches for a particular destination type, destination and duration and then uses this information to find the most reviewed trip.

The system can clone an itinerary from a combination of trip activities, trip type, destination and duration. The logic chooses the most reviewed and top-rated trip. In absence of the reviews, choose the trip which is most complete. If multiple trips are complete, choose the latest one. One definition of complete is that all the days are filled. There is travel at the start and end of the trip, there is stay at the end of each day. There is food consumption each day. Efficiency is obtained by choosing the fastest path to getting to the perfect itinerary to clone. The search result is displayed with a small preview of the picture on the itinerary which tells the user what to expect.

The app includes the ability to share a clone of the itinerary and invite friends to edit the itinerary. Editing is done by everyone who has permission to edit the itinerary. Each person can choose the sections which they want to edit and then save their changes. Once a user has made some changes, he can clone it to make a copy for himself or he can add his own sections to the itinerary if he does not like the sections cloned from another person. Activity details page for each activity in the itinerary Each activity in the itinerary is supposed to have its own activity details page. Example Use cases may include:

1. User has 2 hours free time, wants to visit new place and make plans to visit the new place during free time. The user searches for itineraries which meet the criteria of new places nearby (timedistance-budget), looks at pictures, reviews, number of people having traveled in that itinerary, gets the details of how to get there from origin and travel time. He then checks in with friends/family and clicks on a few people’s check-ins. Then, he decides to build his own itinerary by taking inspiration from the other users itinerary. He clicks on their itinerary, and sees the itinerary template. He decides to clone the entire itinerary and to change a few activities. He is done in 10 minutes.

2. While on a trip, one user adds photos to his itinerary, and updates his friends that he has finished his trip. He is rewarded with credits. Credits can be used to purchase advertisements to share his itinerary or used to get discounts on future trips. He updates his itinerary every day with details of what he did, the distance traveled, photos from the day, how much he spent, etc.

3. User shares his itinerary on social media so that his friends can follow him on his trip. Some of his friends like the itinerary and want to add more activities to the itinerary. His friends clone the itinerary and add more activities to the itinerary.

People want to customize their experience for the activity they are doing. They don’t want a set itinerary for the trip. The more options available for personalization, the more users would like to use it. In other words, the more customizable the trip is, the more satisfied the user would be. People would have the option to pick different types of trips and customize the activities they would like to do. In the same time the app will keep track of the amount of time the user spends editing the trip so that the user can have a feeling of completion on his work. It should not be a vague time of editing the trip. The user should feel the progress as he goes through and edits the trip. When the trip is edited, it should also record the name of the person who made the edits so that it is clearly shown who did what. The person making the edits should also be able to assign an event to that particular activity on the itinerary. This makes the person feel proud of what he did. He should also be able to give an evaluation of how much he enjoyed that activity. So that when another person views the itinerary and sees the activity, he will be more inclined to go for that activity. A similar situation can be extrapolated to how one takes pride in organizing something like arranging the seating arrangement at a wedding, sorting out the guest list for a party, etc.

Any search in the system would be a complex combination of all the parameters that make up an itinerary. If an individual was to search for an itinerary, it would involve multiple categories to search on. These categories include trip type, origin, destination, date range, duration, activities, who is traveling, people to share with and any other parameters specific to the activity category. Any number of the above categories can be included in the search. Once the results are shown for a given search, the user can select one of the returned itineraries as the base to clone from. Then a menu appears on the screen where the user can clone activities, edit the date and duration, share it with other people, share it on social media sites and delete the existing itinerary.

Itinerary contains trip itinerary, places to visit, transportation and accommodation needed to make a trip successful. It is further broken down into activities performed at a particular location and events scheduled in between. This makes the planning easier and convenient for the trip. The people who plan the trip collaboratively can share it with others to enjoy their experience in a trip. Most of the content from the planning is available from internet websites and print media. However, the content cannot be organized for users to be able to understand and work with the content. Most of the itineraries on the internet are static. One cannot modify it for their needs. Hence this application allows one to create their own itinerary by choosing content from itineraries already created by other people.

For one to be able to share a trip with others, people will have to get registered. The website allows for individuals to create an account with basic information about the person. It allows for individuals to upload photos which are used as thumbnails of the activities in the itinerary to help others understand what the activity is. The website has no way of identifying the actual person behind the account. Activity types that can be added: restaurant, attraction, nature, city and other types

The app includes the ability to search for existing trips from the website with origin, destination, duration and activities. The app shows existing itineraries for the chosen category in search result. If multiple trips exist for a particular origin and destination, the top ranked and most reviewed itinerary is shown. If multiple itineraries exist for a particular combination of origin, destination, duration and activities, the itinerary which was last modified is shown. Other features include:
Ability to view the activity types of the search result
Edit the activity type in search result
In the search result, shows an activity based on time when all the days are not full. Activity is the union of the category and the time it is done. In the absence of activity time, category name is shown
For activity time search, activity time is defaulted to the time period of the search result day

That perfect itinerary for the user is obtained by cloning other people’s itinerary and choosing activities which are either the same or similar to what the user want to do, thereby eliminating any hassle of planning a trip on the user own and thinking of what to do. Cloning a trip consists of selection of parts of another itinerary from a number of other options of trip activities, trip type, destination and duration.

FIGS. 4-10 show exemplary user interface for the system of FIG. 1. As shown in these exemplary Uls, the following features are supported:
Search by destination: destination is selected by integration with google map APIs. This is a typeahead. Destination can be city, country
Search by duration: duration is specified in number of days they trip must be
Search by Trip type: This is a predefined set of categorization that allows the user to search from options: relaxing, packed, mixed, focused on one activity. This categorization is specific to this app and this paper
Search by Trip Activities: This can be any set of activities a person would like to do during the trip eg. wine tasting, chocolate tasting, sightseeing etc. These activity type are curated manually by observing multiple itineraries across various the globe. These activities are specific to the app and this paper
Search by influencer: People like to follow itineraries by certain profile names famous for good itineraries. So option is provided for people to search by itinerary creator.
Search by any of the criteria. Search by a combination of attributes or none of the attributes: users can combine these vrious search criteria or use none at all
Search result (latest):the search criteria is used as an ‘and’ condition. The results are obtained from a database and deduplicated to only keep one trip with the combination of trip activities, destination, trip type and number of days. Sorting is done by the most frequent repetition of combinations of destination, activities, trip type and number of days.
Search result (popular): sorting is done by most recent trip created
Destination: Destination appears in search result to show where the itinerary is focused on. If there are multiple destinations, then the user has to choose one
Trip type: This is a custom defined type built for the app. It has following possible values: relaxing, packed, mixed, focused on one activity
Duration: Number of days the trip lasted
Trip activities: activities one does while on a trip. There are numerous activities available to view
User can click clone trip to be able to create an itinerary with the same set of destination, trip type, duration, activities. In the background the last trip with the highest rating is chosen to clone. In future we want to run a recommendation engine based on past trips to pick an itinerary that is ideal for the user. Once a trip is cloned, it appears in “my trip” and can be edited to fit user’s needs
User can click ‘more like this’ button to get more detailed itineraries to choose from and check out the differences
Profile name of person who created the trip can be saved
More detailed search result: Want to use an advertisement model as revenue generating mechanism. More a particular itinerary is seen, the more ad money the itinerary creator can make. There could be ads label for any trip activity business mentioned in the trip activity details. Also the trip with ads can appear on top over other itineraries with good ratings

A trip can be a promoted trip. So it would appear on top of the list.
Trip creators can get sponsorship from a business to promote them. So the trip creator can add them as part of the trip and get sponsorship money
User can clone an itinerary after looking at the details
User can clone selected parts of the itinerary to add to their own itinerary
User can add review for the itinerary to indicate how they like the itinerary
If clone selected, then user has to choose which itinerary amongst existing initneraries to add the items to in a model window
Once clone itinerary button is clicked, the user will go to the create Trip page where user can edit the name of the trip and keep destination, User can also edit the dates of the itinerary.
Name of Trip: User can give any name for their trip for them to remember the
Destination: User can choose the destination they wish to go to. It could be a town, it could be a country. There is no restriction as long as it is available in google maps api
The trip start date and end date are required. End date cannot be less than start date.

The UI provides a number of buttons which allow the user to select what type of travel they want to plan, either single or multiple destinations. There is also a search button which allows a user to search for a trip with respect to its activities, time and place. The search algorithm filters the search results for trips which have the activities the user selected. The user is then shown all the available options which are an amalgamation of the best options based on factors like reviews, popularity and price, for example. If there are multiple options with the same number of activities, the options are presented to the user in order of price, ascending order. The activity options are presented to the user to choose one of them.

Photo collections is supported on the level of activity/ location. The system can share itinerary for collaborative editing of the trip. This application maintains a persistent backend that supports editing on mobile device or desktop. This brings out the best in cross-platform design as one is not bound to either desktop or mobile. In one example provides Itinerary view: A map is shown with locations and activities plotted. When the user zooms in to see the detailed information, it turns into a map with pins with title. The pins can be clicked to read details of the place/ activity. Information shown is activity, title, date, duration, location, address and price. To keep it simple, most of the photos and activities are shown in the list view. Activities with no photo show as title only. Activity info is linked to individual photo. This keeps the content crisp and clear. Click on map to get to a more detailed view of pins Click on map to get to a more detailed view of pins Click on pin to get more details about the place/ activity Click on pin to get more details about the place/ activity There is also a slide out box which displays top 10 destinations based on ratings.

While viewing an itinerary, it should be possible to book any of the trip activities like hotels, restaurants or other transportation like buses, boats or flights. Each activity has a form that gets filled up by the user with information like cost and number of people. While building the itinerary, users can save a draft of the itinerary. This allows the users to come back later and add more things to the itinerary. When one is adding a restaurant for lunch, he can choose between various restaurants that are nearby. All the restaurants available in the area should be listed with their menu and information about them. The user can make reservations with the selected restaurants. The user should be able to order the food and pay for it using credit card. When ordering food, the app can push notification on the delivery location to bring the food. Or alternatively, the app can also push a notification to the restaurants to get the food to the location. Widgets on a dashboard to track how many activities the user have booked, places the user have booked and how much time is left for the user trip. If a user starts editing his itinerary, he will get a sense of how much time is left and how many things he needs to do. This gives him a clear idea of what needs to be done and helps him plan ahead for things to be done on time.

One embodiment provides the following features:
1. Plan a trip, take the trip, view it as memory, share with friends and family This is what an itinerary does. It’s about getting there, doing things, and going back home. How does this help us plan a trip? There are four parts of a trip, Origin, Destination, Activities and Transportation. A trip can be just one of these parts or a combination of all of them. The app lets the user select a combination of these and see the possible combinations and pick one that the user like the most. The user can also see what other people have planned on their trip and the user can use those ideas to plan the user trip.
2. The time it takes to create an itinerary has been reduced by half due to the availability of public itineraries that the user can clone
3. Searching for trips takes less than a minute to find suitable trips for different users based on filters set by the user.
4. The data on itineraries is easily navigable and understandable for other users who want to travel along with the user.
5. Shared trips provide updates from one person who has cloned the itinerary and added updates to other users who have cloned the itinerary.

The user can go for a trip and the user see some itineraries on the search results. There could be many combinations of trip activities, destination and duration. But there is no option to clone from a particular combination of trip activities, trip type, destination and duration. For example, if the user want to clone from road trip with duration of 2 days, where the first day is travel from home to destination and the second day is visit Disneyland, then that particular combination is not available for cloning. It’s difficult to find such combination on the search results. Hence when one finds an itinerary that closely matches his/her requirements, he/she can clone it by selecting only that particular combination. The clone of the itinerary can be modified to suit the user requirements. The system can clone parts of an itinerary into one’s own itinerary If the user like some parts of an itinerary and wish to add those parts to the itinerary.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method to plan a trip, comprising:
viewing one or more prior trip files shared by one or more travelers, wherein the trip file includes images and descriptions of one or more sub-destinations in the prior trips, activities done, and routes and travel methods to get to the one or more sub-destinations;
selecting a prior itinerary based on trip images and trip description type, activities done, person who created the itinerary, destination, and duration;
cloning a complete or a part of itinerary from the prior trip;
modifying the trip to fit a user preference;
sharing itinerary with co-travelers for edits;
booking all components of the itinerary; and
auto checking in at the one or more points of interest and travel.

2. The method of claim 1, comprising searching for itineraries.

3. The method of claim 1, comprising source itinerary from other people.

4. The method of claim 1, comprising cloning itinerary.

5. The method of claim 1, comprising personalizing the trip based on user preference.

6. The method of claim 1, comprising search for trip and then go to detail search given all the criteria for an itinerary.

7. The method of claim 1, comprising sharing a trip so that others can edit.

8. The method of claim 1, comprising sharing a trip with others to view.

9. The method of claim 1, comprising create, edit, share, plan as well as view after the trip.

10. The method of claim 1, comprising storing photos at the level of individual activity or location.

11. The method of claim 1, comprising booking trip activities while viewing as an itinerary level.

12. The method of claim 1, comprising displaying a user interface to plan a trip, take the trip, view the trip afterward, and share with friends and family.

13. The method of claim 1, comprising adding items from different itineraries.
